(19) United States
(12) Patent Application Publication
(10) Pub. No.: US 2019/0077572 A1
(43) Pub. Date: Mar. 14, 2019

(54) SHEET MATERIAL AND ALCOHOL TRANSPIRATION AGENT PACKAGE USING THE SHEET METAL

(71) Applicant: JXTG Nippon Oil & Energy Corporation, Tokyo (JP)

(72) Inventors: Tomoyuki Okamura, Tokyo (JP); Keiichi Ootsubo, Tokyo (JP)

(73) Assignee: JXTG Nippon Oil & Energy Corporation, Tokyo (JP)

(21) Appl. No.: 16/084,809

(22) PCT Filed: Mar. 31, 2017
(86) PCT No.: PCT/JP2017/013700

§ 371 Date: Sep. 13, 2018

(30) Foreign Application Priority Data
Mar. 31, 2016 (JP) 2016-072003

(51) Int. Cl. B65D 81/28; B65D 75/26; A23L 3/3445; B32B 27/32; B32B 27/34; B32B 7/02

(52) U.S. Cl. CPC B65D 81/28; B65D 75/26; A23L 3/3445; B65D 65/40; B32B 27/34; B32B 7/02; B32B 27/32

(57) ABSTRACT

To provide a sheet material capable of suppressing reduction in moisture or ethanol permeability while maintaining desired strength, and an alcohol transpiration agent package using the same. A sheet material 11 includes a mesh-like structure 12 and a polyamide-based resin film 13. The mesh-like structure is made up of two or more uniaxially oriented members including a thermoplastic resin layer and a linear low-density polyethylene layer laminated on at least one side of the thermoplastic resin layer, and is obtained by laminating or weaving the two or more uniaxially oriented members through the linear low-density polyethylene layer so as to cross orientation axes of the two or more uniaxially oriented members. A polyamide-based resin film is laminated on the mesh-like structure through the linear low-density polyethylene layer. The mesh-like structure and the polyamide-based resin film are bonded together by the melted linear low-density polyethylene layer of the mesh-like structure.

### TECHNICAL FIELD

The present invention relates to a sheet material obtained by laminating a mesh-like structure and a polyamide-based resin film, and to an alcohol transpiration agent package using the sheet material.

### BACKGROUND ART

Patent Document 1 discloses a packaging sheet obtained by laminating a nylon film and nonwoven fabric made of a thermoplastic resin the melting point of which is lower than that of nylon. Also, it discloses an alcohol transpiration agent package (bag) obtained by filling the alcohol transpiration agent into a bag made with the above packaging sheet.

### REFERENCE DOCUMENT LIST

### Patent Document

Patent Document 1: JP 2003-211604 A

### SUMMARY OF THE INVENTION

### Problem to be Solved by the Invention

Patent Document 1 describes laminating the nylon film and the nonwoven fabric by pattern dry lamination. In this method, the nylon film and the nonwoven fabric are bonded using an adhesive, and the adhesive may clog the nonwoven fabric, lowering moisture or ethanol permeability. If the mesh opening of the nonwoven fabric is increased so as to avoid such clogging, the strength of the packaging sheet deteriorates. Thus, it is difficult to ensure the desired moisture or ethanol permeability and the desired strength of the packaging sheet simultaneously.

Moreover, in making a bag with the packaging sheet and filling an alcohol transpiration agent into the bag, bonding is carried out by heat sealing. A heat sealing layer has to be interposed at the bonding portion, and this complicates the manufacturing apparatus and process.

The present invention has been accomplished in view of the above circumstances and accordingly, it is an object of the present invention to provide a sheet material that can prevent reduced moisture or ethanol permeability while maintaining desired strength, and also to provide an alcohol transpiration agent package using the sheet material.

### Means for Solving the Problem

According to an aspect of the present invention, provided is a sheet material comprising: a mesh-like structure which is made up of two or more uniaxially oriented members including a thermoplastic resin layer and a linear low-density polyethylene layer laminated on at least one side of the thermoplastic resin layer, and which is obtained by laminating or weaving the two or more uniaxially oriented members through the linear low-density polyethylene layer so as to cross orientation axes of the two or more uniaxially oriented members; and a polyamide-based resin film laminated on the mesh-like structure through the linear low-density polyethylene layer, the mesh-like structure and the polyamide-based resin film being bonded together by the melted linear low-density polyethylene layer of the mesh-like structure.

According to another aspect of the present invention, provided is an alcohol transpiration agent package in the form of a bag that is heat-sealed with an alcohol transpiration agent filled therein, the package comprising: a mesh-like structure which is made up of two or more uniaxially oriented members including a thermoplastic resin layer and a linear low-density polyethylene layer having long-chain branching in a molecular chain and laminated on at least one side of the thermoplastic resin layer, and which is obtained by laminating or weaving the two or more uniaxially oriented members through the linear low-density polyethylene layer so as to cross orientation axes of the two or more uniaxially oriented members; a polyamide-based resin film laminated on the mesh-like structure through the linear low-density polyethylene layer; and a printed surface formed on a side of the polyamide-based resin film at which the mesh-like structure is laminated, wherein the alcohol transpiration agent is filled in the bag that is formed with the mesh-like structure inside, and the linear low-density polyethylene layer of the mesh-like structure is used as a heat sealing layer for bonding contact portions of the mesh-like structure to seal the bag.

### Effects of the Invention

According to the sheet material of the present invention, the mesh-like structure and the polyamide-based resin film are directly bonded together by a melted linear low-density polyethylene layer of the mesh-like structure, whereby no adhesive is required. Consequently, there is neither a fear of impairing the moisture or ethanol permeability nor a necessity to increase the mesh opening of nonwoven fabric so as to avoid clogging. Thus, desired tensile and penetration strengths can be maintained.

Also, according to the alcohol transpiration agent package of the present invention, when making a bag with the sheet material, the linear low-density polyethylene layer of the mesh-like structure on the inner side of the bag can be used as a heat sealing layer for bonding. This makes it possible to dispense with a heat sealing layer and in turn, simplify manufacturing apparatus and process. Moreover, since a printed surface does not appear on the outer side of the alcohol transpiration agent package (printing is performed on the underside of the sheet), when the alcohol transpiration agent package is filled into a food packaging container together with food, the food never touches an ink of the alcohol transpiration agent package and thus, unsuccessful printing of the ink or undesired ink transfer to the food can be prevented.

### BRIEF DESCRIPTION OF THE DRAWINGS

FIG. 1A is a perspective view of a sheet material according to a first embodiment of the present invention.

FIG. 1B is a cross-sectional view of the sheet material according to the first embodiment of the present invention.

FIG. 2 is a flowchart showing a manufacturing process for the sheet material shown in FIGS. 1A and 1B.

FIG. 3A is a perspective view of an alcohol transpiration agent package using the sheet material shown in FIGS. 1A and 1B, according to a second embodiment of the present invention.

FIG. 3B is a cross-sectional view of the alcohol transpiration agent package using the sheet material shown in FIGS. 1A and 1B, according to the second embodiment of the present invention.

FIG. 4 is a flowchart showing a manufacturing process for the alcohol transpiration agent package shown in FIGS. 3A and 3B.

FIG. 5 is a plan view showing mesh-like nonwoven fabric as an example of a mesh-like structure used in the sheet material shown in FIGS. 1A and 1B.

FIG. 6A is a perspective view showing a structural example of uniaxially oriented members constituting the mesh-like nonwoven fabric shown in FIG. 5.

FIG. 6B is a partially enlarged perspective view showing the structural example of the uniaxially oriented members constituting the mesh-like nonwoven fabric shown in FIG. 5.

FIG. 7A is a perspective view showing a structural example of uniaxially oriented members constituting the mesh-like nonwoven fabric shown in FIG. 5.

FIG. 7B is a partially enlarged perspective view showing the structural example of the uniaxially oriented members constituting the mesh-like nonwoven fabric shown in FIG. 5.

FIG. 8 is a perspective view illustrating a manufacturing process for the uniaxially oriented member shown in FIGS. 6A and 6B.

FIG. 9 is a perspective view illustrating a first manufacturing process for mesh-like nonwoven fabric.

FIG. 10 is a perspective view illustrating a second manufacturing process for mesh-like nonwoven fabric.

FIG. 11 is a plan view showing nonwoven fabric made up of a uniaxially oriented tape as another example of the mesh-like structure.

FIG. 12 is a perspective view showing woven fabric made up of a uniaxially oriented tape as another example of the mesh-like structure.

FIG. 13 shows results of measuring strength, moisture permeability, ethanol permeability, etc. of plural samples prepared with different material compositions according to embodiments of an alcohol transpiration agent package of the present invention.

### MODE FOR CARRYING OUT THE INVENTION

Embodiments of the present invention are described with reference to the accompanying drawings, but the present invention is not limited to the following embodiments.

### First Embodiment

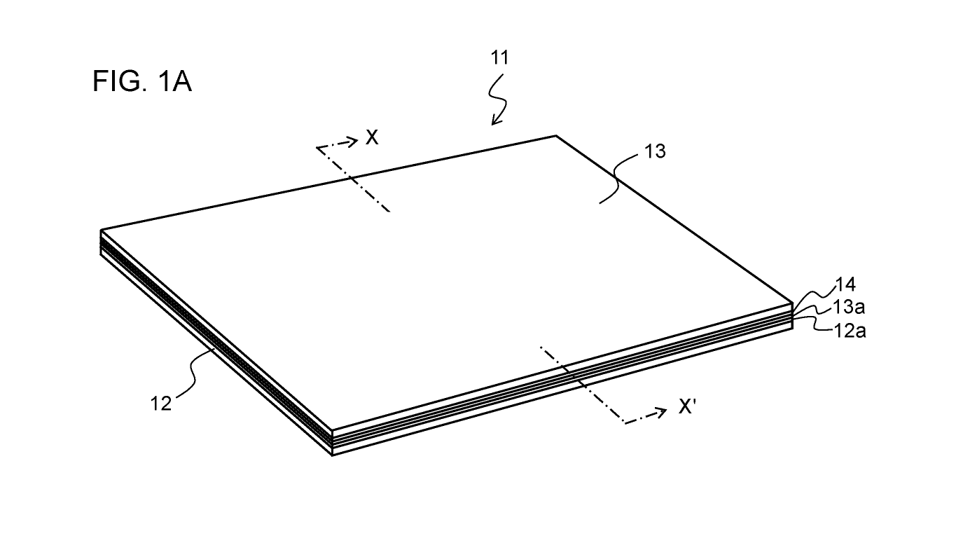

FIGS. 1A and 1B show a sheet material according to a first embodiment of the present invention, in which FIG. 1A is a perspective view thereof, and FIG. 1B is a cross-sectional view of the sheet material taken along line X-X′ of FIG. 1A. A sheet material 11 has a laminate structure of a mesh-like structure 12 and a polyamide-based resin film, i.e., a so-called nylon film 13. The mesh-like structure 12 and the nylon film 13 are bonded together by a melted linear low-density polyethylene layer of the mesh-like structure 12. The polyamide-based resin film has alcohol permeability, preferably ethanol permeability, of 300 g/m²·24 hr or more. Note that any film having the laminate structure of plural materials including a polyamide-based resin can be used as long as it has the alcohol permeability.

The mesh-like structure 12 includes two or more uniaxially oriented members having a thermoplastic resin layer and a linear low-density polyethylene layer laminated on at least one side of the thermoplastic resin layer. The two or more uniaxially oriented members constitute at least one of a uniaxially oriented mesh-like film and a uniaxially oriented tape. The two or more uniaxially oriented members are laminated or woven through the linear low-density polyethylene layer, such that orientation axes of the two or more uniaxially oriented members cross each other. The linear low-density polyethylene layer serves as a bonding layer for bonding the two or more uniaxially oriented members arranged so as to cross their orientation axes. Various examples and specific structural examples of the mesh-like structure 12 are outlined below. A detailed description thereof is given later.

For example, the uniaxially oriented member includes a first linear low-density polyethylene layer laminated on one side of the thermoplastic resin layer and a second linear low-density polyethylene layer laminated on the other side of the thermoplastic resin layer. These first and second linear low-density polyethylene layers are made of linear low-density polyethylene having long-chain branching in a molecular chain. Alternatively, if the mesh-like structure 12 is formed by weaving two or more uniaxially oriented members, the linear low-density polyethylene layer can be made of linear low-density polyethylene polymerized with a metallocene catalyst.

To give an example, the first and second linear low-density polyethylene layers are made of linear low-density polyethylene with a melt flow rate (MFR) of 0.5 to 10 g/10 min and density of 0.910 to 0.940 g/cm³.

In this case, the mesh-like structure 12 satisfies required characteristics: fabric mass per unit area is 5 to 70 g/m², the thickness of the linear low-density polyethylene layer is 2 to 10 μm, adhesion between the uniaxially oriented members is 10 to 60 N, and tensile strength is 20 to 600 N/50 mm.

On the other hand, the nylon film 13 is laminated on the mesh-like structure 12 through a linear low-density polyethylene layer and bonded to the mesh-like structure 12 by the melted linear low-density polyethylene layer. A printed surface 14 is on the side of the nylon film 13 at which the nylon film 13 is laminated on the mesh-like structure 12. To a surface area 12a, 13a of at least one (in this example, both) of bonding surfaces of the mesh-like structure 12 and the nylon film 13, polar functional groups are introduced by corona treatment.

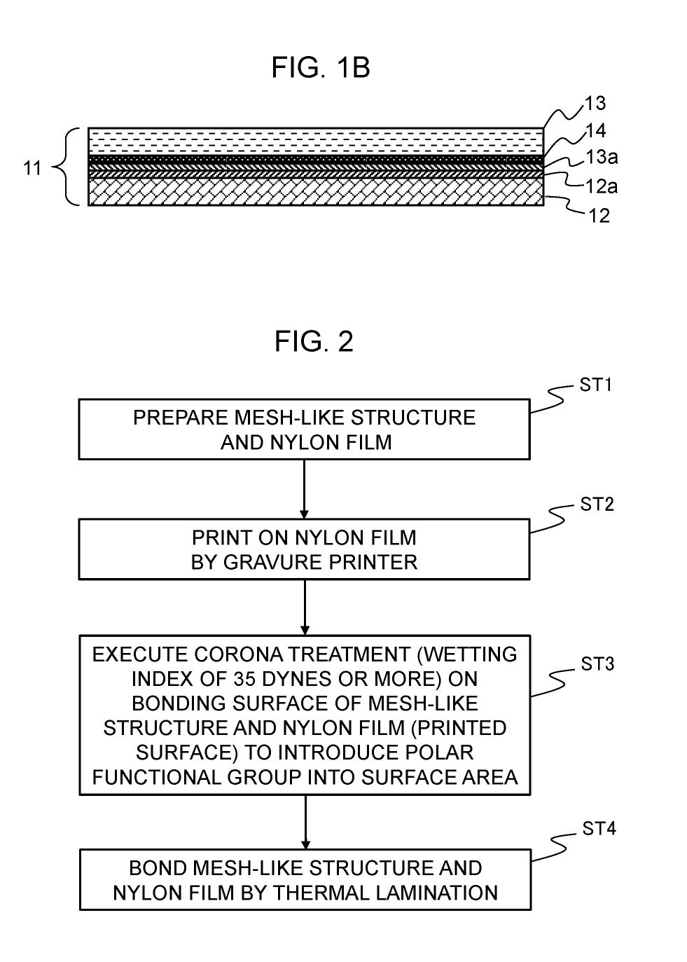

FIG. 2 is a flowchart showing a manufacturing process for the sheet material shown in FIGS. 1A and 1B. First, the mesh-like structure 12 and the nylon film 13 are prepared (ST1), and printing is executed on the nylon film 13 by a gravure printer to form the printed surface 14 (ST2). Next, the bonding surfaces of the mesh-like structure 12 and the nylon film 13 (printed surface) are subjected to corona treatment (wetting index of 35 dynes or more) to introduce a polar functional group into the surface area 12a, 13a so as to modify a target surface of a base material to improve hydrophilicity (ST3). After that, the mesh-like structure 12 and the nylon film 13 are bonded together by thermal lamination (ST4). In this bonding step, the laminated mesh-like structure 12 and nylon film 13 are nipped between a pair of oppositely arranged heating rolls to pass therethrough. Thus, the linear low-density polyethylene of the mesh-like structure 12 is melted at about 100 to 130° C. to thereby bond them.

As mentioned above, the linear low-density polyethylene can be used, if melted, for bonding the mesh-like structure 12 and the nylon film 13 as well as used as a bonding layer for bonding the uniaxially oriented members. Thus, the mesh-like structure 12 and the nylon film 13, which are originally difficult to bond, can be directly bonded together, and an adhesive is not required. There is accordingly no risk that an adhesive will clog the mesh-like structure 12, reducing the moisture or ethanol permeability. Also, there is no need to increase the mesh opening of the nonwoven fabric and therefore, desired tensile and penetration strengths can be maintained. Moreover, since water-resistant, oil-resistant paper such as rayon mixed paper is not used, paper dust and fuzz are not involved, and lint-free (dustproof) characteristics are realized. Also, since a nonporous nylon film is used, when the sheet is formed into a bag and powder is put in the bag, the powder does not leak from the bag.

### Second Embodiment

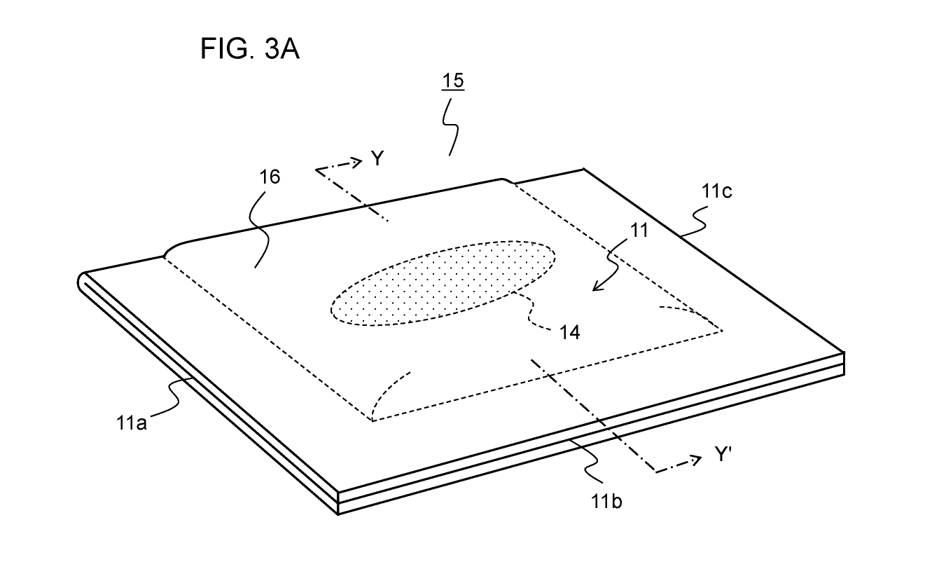

FIGS. 3A and 3B show an alcohol transpiration agent package using the sheet material shown in FIGS. 1A and 1B, according to a second embodiment of the present invention. FIG. 3A is a perspective view of the alcohol transpiration agent package, and FIG. 3B is a cross-sectional view of the sheet material taken along Y-Y′ line of FIG. 3A. In FIG. 3B, the surface area 12a, 13a in which the polar functional group is introduced and the printed surface 14 are not shown, and the sheet material 11 is illustrated as having the two-layer structure of the mesh-like structure 12 and the nylon film 13.

The alcohol transpiration agent package 15 is a bag-like package heat-sealed with the alcohol transpiration agent 16 enclosed therein. The alcohol transpiration agent package 15 is made up of the sheet material 11 having the laminate structure of the mesh-like structure 12 and the nylon film 13. The printed surface 14 is formed on the nylon film 13 at the laminated portion between the mesh-like structure 12 and the nylon film 13. Then, the alcohol transpiration agent 16 is enclosed into a bag that is formed with the mesh-like structure 12 inside and is sealed (bonded) using the linear low-density polyethylene layer of the mesh-like structure 12 on the inner side of the bag, as a heat sealing layer. In the illustrated example of FIGS. 3A and 3B, one sheet material 11 is folded and bonded along the remaining three sides 11a, 11b, and 11c so as to seal the alcohol transpiration agent 16. Alternatively, two sheet materials can be bonded along their four sides.

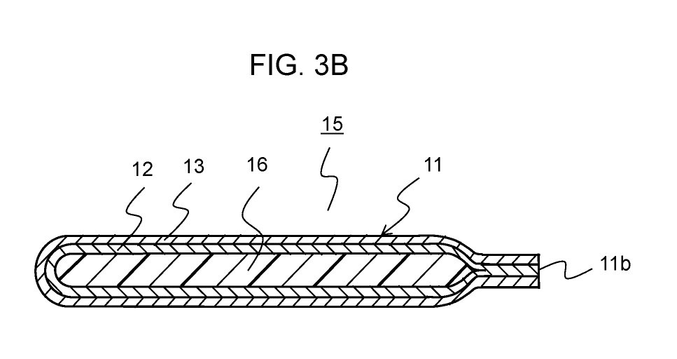

FIG. 4 is a flowchart illustrating a manufacturing process for the alcohol transpiration agent package 15 shown in FIGS. 3A and 3B. FIG. 4 shows a process from production of the sheet material 11 to that of the alcohol transpiration agent package 15. The sheet material 11 is formed through the above steps ST1 to ST4, after which the bonded original fabric is slit into a predetermined bag size (ST5). Subsequently, the bonded original fabric thus slit is folded and its two sides orthogonal to the fold are bonded by thermal fusion to form a bag, and the alcohol transpiration agent 16 is enclosed thereinto (ST6). At this time, the sheet material 11 is folded with the mesh-like structure 12 inside, and the linear low-density polyethylene layer of the mesh-like structure 12 is used as a heat sealing layer to bond the two sides 11a and 11c orthogonal to the fold. Next, the linear low-density polyethylene layer of the mesh-like structure 12 is used as a heat sealing layer to bond the remaining side 11b with the alcohol transpiration agent 16 filled in the bag, to thereby seal the alcohol transpiration agent 16 (ST7).

According to the above structure and manufacturing process, the linear low-density polyethylene layer can be used for bonding the uniaxially oriented members and welding the mesh-like structure 12 and the nylon film 13, and also can be used as a heat sealing layer upon forming the sheet material 11 into a bag, so as to bond the mesh-like structure 12 on the inner side of the bag. Accordingly, the heat sealing layer is not required, whereby the manufacturing apparatus and process can be simplified. Moreover, since printing is performed on the underside of the sheet, when the alcohol transpiration agent package is enclosed in a food packaging container together with food, the food does not touch an ink of the printed surface 14 and thus, unsuccessful printing of the ink or undesired ink transfer to the food can be prevented.

Next, various examples or specific structural examples of the above mesh-like structure 12 are described in detail.

First, the layer structure of the uniaxially oriented member constituting the mesh-like structure 12 and the composition of each layer are described. The uniaxially oriented member includes a thermoplastic resin layer and a linear low-density polyethylene layer laminated on at least one side of the thermoplastic resin layer.

The thermoplastic resin layer mainly contains a thermoplastic resin. Conceivable examples of the thermoplastic resin include polyolefin such as polyethylene and polypropylene having satisfactory splittability and a copolymer thereof, and high-density polyethylene is preferred.

The thickness of the thermoplastic resin layer is not particularly limited and can be appropriately determined so as to obtain predetermined fabric mass per unit area when the thickness of the linear low-density polyethylene layer is set to a desired range as mentioned below. The thickness of the thermoplastic resin layer can be approximately 20 to 70 μm, preferably 25 to 60 μm. Note that this thickness means a thickness of a uniaxially oriented layer.

The linear low-density polyethylene layer mainly contains linear low-density polyethylene having a lower melting point than the above thermoplastic resin. For manufacturing reasons, a difference in melting point between the linear low-density polyethylene layer and the thermoplastic resin layer has to be 5° C. or more, preferably 10 to 50° C. The linear low-density polyethylene layer serves as a bonding layer to bond to another uniaxially oriented member as described above and thus, is also referred to as a bonding layer.

The linear low-density polyethylene is preferably polymerized with a metallocene catalyst. The metallocene catalyst is a kind of so-called single-site catalysts with substantially a single active site. This catalyst contains at least a transition metal compound of Group IV of the periodic table containing a ligand having a cyclopentadienyl skeleton. Typically known are catalysts obtained by reacting metallocene complexes of transition metals, for example, biscyclopentadienyl complexes of zirconium or titanium with methyl aluminoxane or the like as a cocatalyst. These are uniform or nonuniform catalysts with various combinations of various complexes, cocatalysts, and carriers. The metallocene catalyst can be a well-known one disclosed in, for example, JP S58-19309 A, JP S59-95292 A, JP S59-23011 A, JP S60-35006 A, JP S60-35007 A, JP S60-35008 A, JP S60-35009 A, JP S61-130314 A, JP H3-163088 A, etc.

The linear low-density polyethylene can be obtained by copolymerizing, in the presence of such a metallocene catalyst, ethylene and α-olefin by a manufacturing process such as gas phase polymerization, slurry polymerization, and solution polymerization. Regarding the copolymer, it is preferred to use α-olefin having 4 to 12 carbon atoms. Specific examples thereof include butene, pentene, hexene, peptene, octene, nonene, and decene.

To give more specific conditions for manufacturing linear low-density polyethylene, it can be produced by polymerizing ethylene and α-olefin in the presence of an inert hydrocarbon solvent selected from aliphatic hydrocarbons such as hexane and heptane, aromatic hydrocarbons such as benzene, toluene, and xylene, and alicyclic hydrocarbons such as cyclohexane and methylcyclohexane in a state in which oxygen, water, etc. are substantially not supplied. The polymerization temperature can be selected from the range of 0 to 300° C. The polymerization pressure can be selected from the range of the atmospheric pressure to about 100 kg/cm². The polymerization time can be selected from the range of 1 min to 10 hrs.

The linear low-density polyethylene polymerized with the metallocene catalyst is different in properties from copolymers prepared with, for example, a Twigler type catalyst or a Phillips type catalyst. The feature thereof is that molecular weight distribution is relatively narrow, and the branching density of the molecular chain is almost uniform. The polymerization of the linear low-density polyethylene with the metallocene catalyst is specifically disclosed in, for example, JP 2009-1776 A or JP H8-169076 A filed by the applicant of the present invention. One skilled in the art could have manufactured the linear low-density polyethylene in the presence of the metallocene catalyst based on the above publications or other prior art. Alternatively, commercially available linear low-density polyethylene that is polymerized with a metallocene catalyst can also be used.

Also, it is more preferred that the linear low-density polyethylene be long-chain branching type linear low-density polyethylene polymerized with a metallocene catalyst. The linear low-density polyethylene having long-chain branching with over 20 carbon atoms is particularly advantageous because of its flexibility and workability from the viewpoint of manufacturing a mesh-like structure. The long-chain branching type linear low-density polyethylene can be prepared by one skilled in the art through appropriate synthesis based on a well-known method, or commercially available long-chain branching type linear low-density polyethylene can be used instead. As a method of introducing long-chain branching, for example, ethylene and α-olefin can be directly copolymerized using a metallocene-based catalyst. In this case, conceivable examples of the metallocene-based catalyst include a complex having a crosslinking biscyclopentadienyl ligand, a complex having a crosslinking bisindenyl ligand, a constrained geometry catalyst, and a complex having a benzoindenyl ligand. Also, the use of a complex having a crosslinking (cyclopentadienyl)(indenyl) ligand is also preferred for the formation of long-chain branching. In the above production examples, the quality and amount of long-chain branching can be controlled by appropriately selecting the type of complex, the conditions for preparing a catalyst, and the polymerization conditions.

Also, as mentioned above, the linear low-density polyethylene preferably has the melt flow rate of 0.5 to 10 g/10 min, more preferably 1 to 5 g/10 min. If the melt flow rate is below 0.5 g/10 min, a pressure load during formation may become large. Also, the rate of more than 10 g/10 min is considered undesirable in some cases because the stability of film formation is low. Moreover, as described above, the density is preferably 0.910 to 0.940 g/cm³, more preferably 0.915 to 0.930 g/cm³. If the density is out of this range, it is difficult to execute thermal bonding between uniaxially oriented members and thus, such density is considered unpreferable in some cases.

As mentioned above, the thickness of the linear low-density polyethylene layer is 2 to 10 μm, preferably 2 to 9 μm, and more preferably 2 to 7 μm. The thickness of less than 2 μm cannot provide satisfactory adhesion. On the other hand, the thickness of more than 10 μm lowers the tensile strength, and the resultant member is soft and cannot ensure satisfactory effects as a reinforcing member. Note that this thickness is of the uniaxially oriented layer.

A resin constituting the thermoplastic resin layer or the linear low-density polyethylene layer can contain a resin other than the above main component such as high-pressure Low Density Polyethylene (LDPE) within a range that does not impair its characteristics. Also, it may contain well-known additives. Conceivable examples of the additives include antioxidants, weathering agents, lubricants, anti-blocking agents, antistatic agents, anti-fogging agents, non-dripping agents, pigments, and fillers.

The linear low-density polyethylene layer can be laminated on either or both of the two sides of the thermoplastic resin layer. The linear low-density polyethylene layers laminated on both sides of the thermoplastic resin layer are referred to as a first linear low-density polyethylene layer and a second linear low-density polyethylene layer. The first and second linear low-density polyethylene layers can have the same composition and thickness or have different compositions and thicknesses. In this context, it is preferred that the first and second linear low-density polyethylene layers satisfy the above conditions for the thickness and the melt flow rate, and also satisfy the above composition conditions in relation to the thermoplastic resin layer.

The uniaxially oriented member is obtained by uniaxially orienting a multilayer film having the above composition and layer structure. The uniaxially oriented member may be, for example, a uniaxially oriented mesh-like film or a uniaxially oriented tape. A detailed description is given below of its form and manufacturing process. The mesh-like structure according to the present invention is made by laminating or weaving at least two uniaxially oriented members. The at least two uniaxially oriented members are laminated or woven so as to cross their orientation axes. At this time, the two uniaxially oriented members may have the same composition and layer structure or have different compositions and layer structures. Depending on characteristics of the uniaxially oriented members, the mesh-like structure can take different forms: mesh-like nonwoven fabric or woven fabric. Also, regarding the crossed orientation axes, they can cross at almost right angles or at predetermined angle. In the case of laminating three or more uniaxially oriented members as well, the orientation axes of the three or more oriented members may cross at predetermined angle. Described below are forms of the uniaxially oriented members and structural examples of the mesh-like structure including a combination thereof.

### (First Mesh-Like Structure: Nonwoven Fabric Made Up of Laminated Split Web and Slit Web)

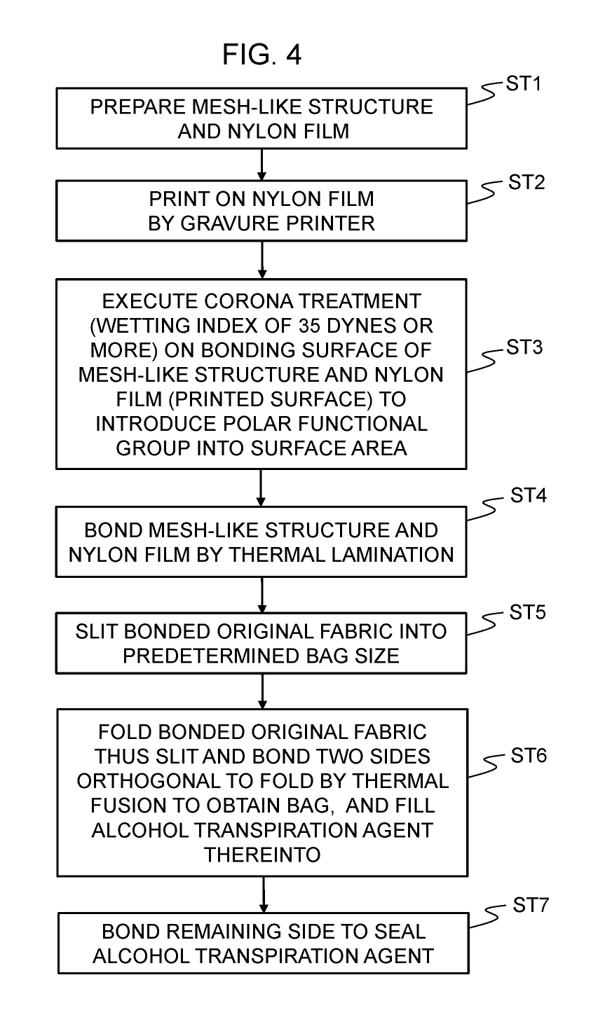

This first mesh-like structure is nonwoven fabric prepared by laminating a uniaxially oriented member obtained by splitting a vertically uniaxially-stretched multilayer film and widening the split film, and a uniaxially oriented member obtained by slitting a multilayer film in the width direction and then uniaxially stretching the slit film in the width direction, so as to cross their orientation directions at almost right angles. FIG. 5 shows a mesh-like nonwoven fabric 1 as an example of the mesh-like structure 12 of the sheet material 11 shown in FIGS. 1A and 1B. The mesh-like nonwoven fabric 1 is formed by vertically and horizontally laminating webs such that an orientation axis L of the split web 2 as an example of the uniaxially oriented member crosses an orientation axis T of the slit web 3 as another example of the uniaxially oriented member. Then, contact portions of the adjacent split web 2 and slit web 3 are joined by surface bonding.

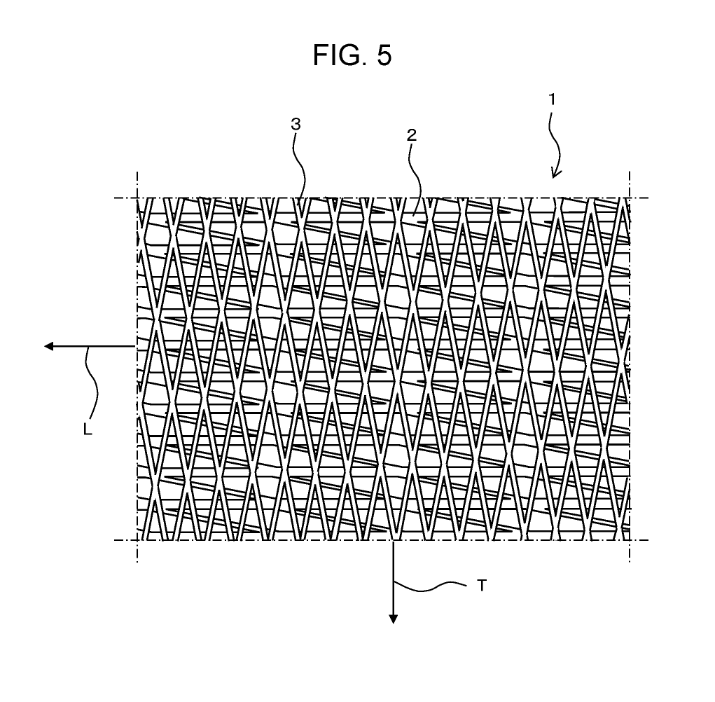

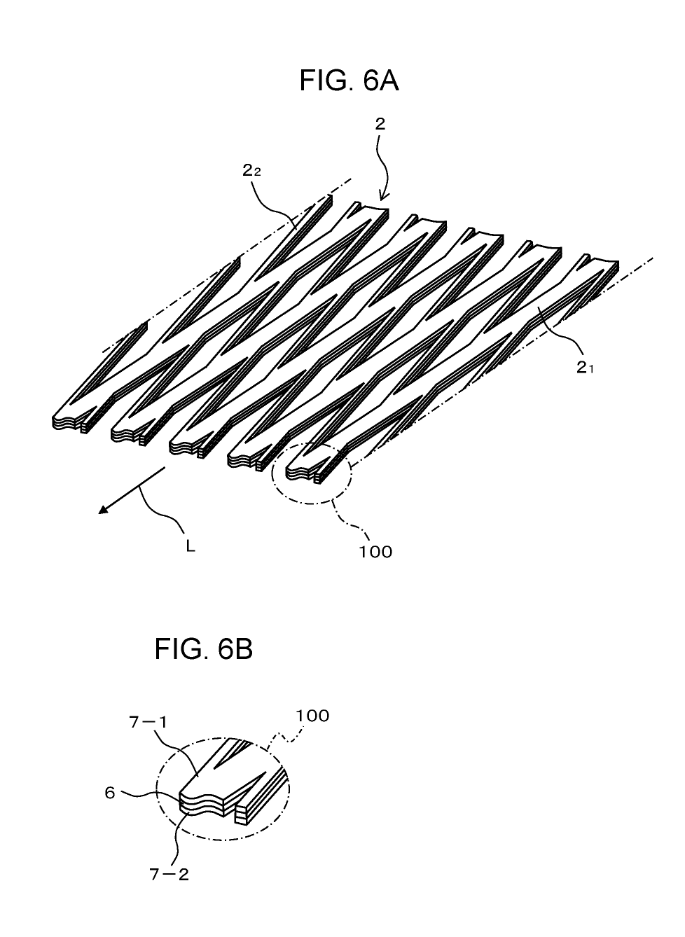

FIGS. 6A and 6B, and FIGS. 7A and 7B show the split web 2 and the slit web 3, which constitute the mesh-like nonwoven fabric 1 shown in FIG. 5. The split web 2 of FIG. 6A is a uniaxially oriented mesh-like film formed by uniaxially stretching a multilayer film obtained by laminating a linear low-density polyethylene layer on one or both sides of a thermoplastic resin layer, in a vertical direction (axial direction of the orientation axis L of the split web 2) and then, splitting the uniaxially stretched film in a vertical direction and widening the split film.

The split web 2 as an example of the uniaxially oriented member made up of the mesh-like film can be manufactured by a manufacturing process such as a multilayer inflation method and a multilayer T-die method. Specifically, a multilayer film is prepared, in which a linear low-density polyethylene layer synthesized with a metallocene catalyst as a preferred example of linear low-density polyethylene is laminated on both sides of the thermoplastic resin layer. In this specification, hereinafter, the linear low-density polyethylene layer polymerized with a metallocene catalyst is also referred to as a metallocene LLDPE layer. This multilayer film is stretched at least three-fold in the vertical direction and then is split (split processing) in an obliquely-angled form with a splitter in the same direction to thereby obtain a mesh-like film. The resultant film is further widened into a predetermined width to complete the desired layer. As a result of the widening, a base fiber 21 and a branch fiber 22 are formed to obtain a mesh-like member as illustrated. The split web 2 ensures a relatively high strength in a vertical direction throughout its width.

FIG. 6B is an enlarged perspective view of a region 100 encircled by dotted chain line of FIG. 6A. In FIG. 6B, the split web 2 has a three-layer structure in which metallocene LLDPE layers 7-1 and 7-2 with a lower melting point than a thermoplastic resin of a thermoplastic resin layer 6 are formed on both sides of the thermoplastic resin layer 6. One of the metallocene LLDPE layers 7-1 and 7-2 functions as a bonding layer for bonding webs when vertically and horizontally laminated together with the slit web 3 at the time of forming the mesh-like nonwoven fabric 1.

The slit web 3 shown in FIG. 7A is a mesh-like film prepared by forming a number of slits in a multilayer film in which a metallocene LLDPE layer is laminated on both sides of the thermoplastic resin layer, in a horizontal direction (axial direction of the orientation axis T of the slit web 3) and then, uniaxially stretching the slit film in the horizontal direction. Specifically, the slit web 3 is prepared by forming discontinuous parallel slits in the multilayer film except both edge portions in an obliquely-angled pattern in a horizontal direction (width direction) by use of, for example, a heat cutter, etc. and then stretching the slit film in the horizontal direction. The slit web 3 ensures a relatively high strength in the horizontal direction.

FIG. 7B is an enlarged perspective view of a region 101 encircled by dotted chain line in FIG. 7A. In FIG. 7B, the slit web 3 has a three-layer structure in which metallocene LLDPE layers 7-1′ and 7-2′ having a lower melting point than a thermoplastic resin of a thermoplastic resin layer 6′ are laminated on both sides of the thermoplastic resin layer 6′. One of the metallocene LLDPE layers 7-1′ and 7-2′ serves as a bonding layer for bonding webs when vertically and horizontally laminated together with the split web 2 at the time of forming the mesh-like nonwoven fabric 1.

To describe the shape of the slit web, the following shape is applicable in addition to the shape of FIGS. 7A and 7B. That is, the slit web can be a uniaxially oriented member having base fibers extending in parallel to each other, and branch fibers for connecting adjacent base fibers, the base fibers being substantially oriented in one direction. This slit web can be obtained by forming a number of slits in an original fabric film with the same structure as that of the split web 2 in a width direction, and stretching the slit film in the width direction at the same stretching rate as the split web 2. More specifically, it is also possible to use as a uniaxially oriented mesh-like film, a slit web having a pattern rotated by ±90° from the position of the split web 2 in plan view or other such patterns.

Note that the three-layer structures of FIGS. 6A and 6B and FIGS. 7A and 7B are illustrated by way of example. For example, the split web 2 may have a two-layer structure of the thermoplastic resin layer 6 and the metallocene LLDPE layer 7-2, without the metallocene LLDPE layer 7-1. Also, the slit web 3 may have a two-layer structure of the thermoplastic resin layer 6′ and the metallocene LLDPE layer 7-2′, without the metallocene LLDPE layer 7-1′. Accordingly, the mesh-like nonwoven fabric 1 can have any combination of two or three split and slit web layers. In the case of bonding uniaxially oriented members of the two-layer structure, a metallocene LLDPE layer of one of the uniaxially oriented members is used for bonding the thermoplastic resin layers and a metallocene LLDPE layer of the other uniaxially oriented member is used for bonding with a nylon film to thereby produce a sheet material.

In this embodiment, as described above, the fabric mass per unit area of the mesh-like nonwoven fabric 1 is 5 to 70 g/m², preferably 7 to 65 g/m², more preferably 10 to 60 g/m². This fabric mass per unit area can be controlled by changing the thickness of the thermoplastic resin layer 6. Also, in this embodiment, as described above, the tensile strength of the mesh-like nonwoven fabric 1 is 20 to 600 N/50 mm, preferably 30 to 550 N/50 mm, more preferably 50 to 500 N/50 mm. This tensile strength can be controlled by changing the thickness of the thermoplastic resin layer 6. In this embodiment, the tensile strength means tensile strength in a vertical direction.

A linear low-density polyethylene layer having high adhesion is used as a surface layer of at least one of the uniaxially oriented members, and the uniaxially oriented members are laminated through the linear low-density polyethylene layer, whereby an adhesion of 10 to 60 N can be ensured between the uniaxially oriented members. The adhesion referred to herein is adhesion of a test piece having the length of 200 mm and the width of 50 mm, which is measured by a tensile strength tester under the measurement conditions that the test piece is pulled in a predetermined direction at a tensile rate of 500 mm/min and an average value of an amplitude of an indicated load value at a displacement of 40 mm to 90 mm is used. The linear low-density polyethylene layer is softer than a general low-density polyethylene layer (LD). However, the thickness of the linear low-density polyethylene layer is reduced to 2 to 10 μm, whereby a thickness ratio of the thermoplastic resin layer to the entire uniaxially oriented member is increased, making it possible to maintain a desired tensile strength.

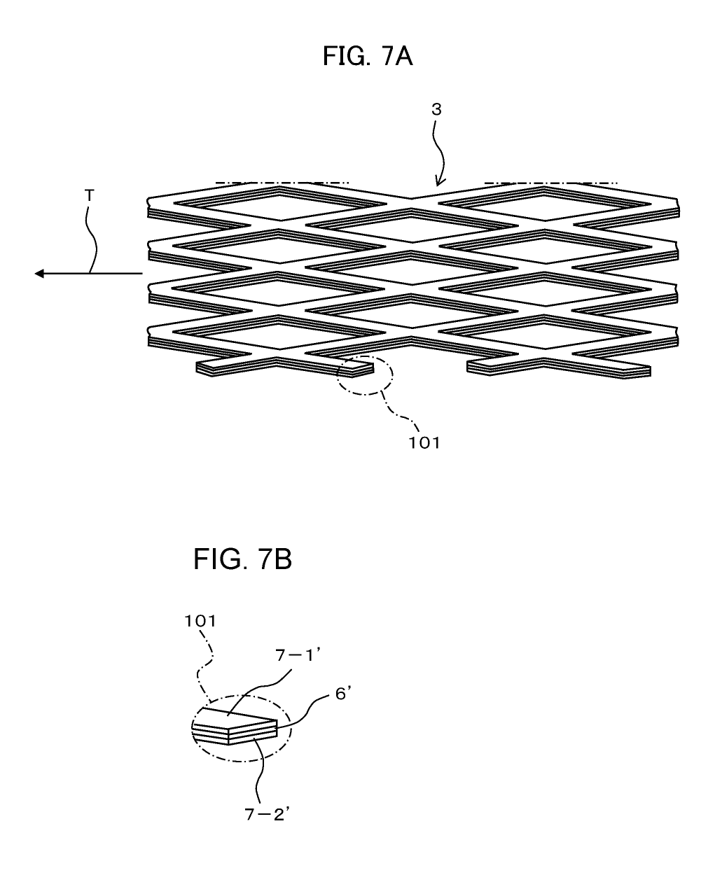

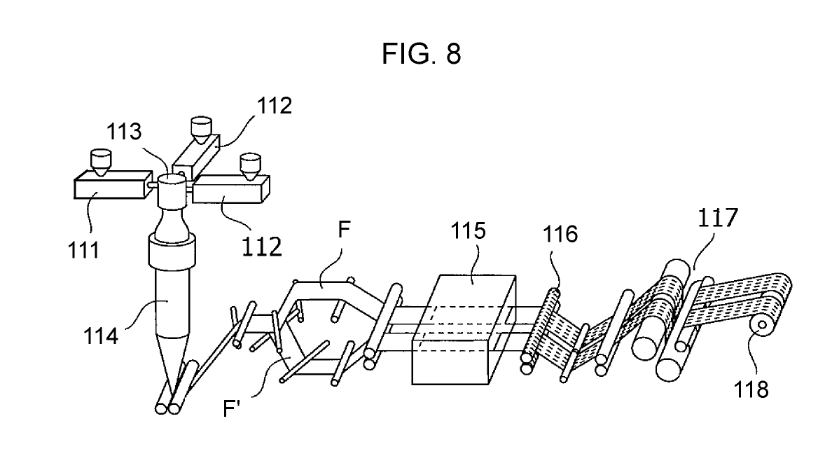

Next, a manufacturing process for the mesh-like nonwoven fabric 1 of FIG. 5 is described with reference to FIGS. 8 and 9. FIG. 8 schematically shows a manufacturing process for the split web 2. FIG. 9 schematically shows a process for laminating the slit web 3 on the split web 2 to produce the mesh-like nonwoven fabric 1.

In FIG. 8, (1) in a process for forming a multilayer film, a thermoplastic resin is supplied to a main extruder 111, a linear low-density polyethylene resin as a bonding-layer resin is supplied to two sub-extruders 112 and 112, the thermoplastic resin extruded from the main extruder 111 is used for a central layer, and the bonding-layer resins extruded from the two sub-extruders 112 and 112 are used for inner and outer layers so as to produce a multilayer film by inflation molding. Here, the thermoplastic resin forms the thermoplastic resin layer 6 shown in FIGS. 6A and 6B, and the linear low-density polyethylene resin forms the linear low-density polyethylene layer 7-1, 7-2 shown in FIGS. 6A and 6B. In the illustrated example of FIG. 8, film formation is executed with three extruders through a multilayer annular die 113 by use of blow-down water-cooled inflation 114. However, as the manufacturing process for the multilayer film, a multilayer inflation method, a multilayer T die method, and the like can be used without any particular limitations.

(2) in an orientation process, the above formed annular multilayer film is split into two films F and F′ and passed inside an oven 115 equipped with an infrared heater, a hot air blower, etc. while heated at a predetermined temperature, and roll-oriented at an orientation ratio of 3 to 15, preferably 5 to 12, more preferably 6 to 10 relative to an initial size by use of a mirror-finished cooling roller. If the stretching ratio is less than 3, it is possible that sufficient mechanical strength cannot be obtained. On the other hand, the stretching ratio of more than 15 makes it difficult to stretch the film by a general method, leading to a problem that expensive equipment may be required, for example. It is preferred to stretch the film at multiple steps so as to prevent the film from being nonuniformly stretched. The above orientation temperature is not higher than a melting point of the thermoplastic resin of the central layer. It is generally 20 to 160° C., preferably 60 to 150° C., more preferably 90 to 140° C., and the orientation process is preferably carried out in multiple stages.

(3) In a splitting (fiber splitting) process, the above oriented multilayer film is subjected to splitting (fiber splitting) through sliding-contact with a splitter (rotating blade) 116 rotating at a high speed. Regarding a splitting method, a number of fine slits can be formed by a mechanical method such as a method of tapping a uniaxially oriented multilayer film, a method of twisting the film, a method of slidingly scraping (rubbing) the film, and a method of brushing the film, an air-jet method, an ultrasonic method, a laser method, etc. in addition to the above method. Of these, the rotational mechanical method is particularly preferred. In such a rotational mechanical method, splitters of various shapes such as a tap screw type splitter, a file-like rough surface splitter, and a needle roll-like splitter can be used. For example, as the tap screw type splitter, a polygonal splitter, generally, a five or six-angled one with 10 to 150 threads, preferably 15 to 100 threads, per inch is used. As the file-like rough surface splitter, a splitter disclosed in JP S51-38980 B is preferred. The file-like rough surface splitter is produced in such a way that the surface of its circular shaft in cross section is processed into a round file for ironworking or other such rough surface ones, and two spiral grooves are formed in the surface at regular pitches. Specific examples thereof are disclosed in U.S. Pat. No. 3,662,935, U.S. Pat. No. 3,693,851, and the like. Although not particularly limited, a preferred manufacturing process for the split web 2 is to move a uniaxially oriented multilayer film under certain tension so as to slidingly contact a splitter that is disposed between nip rolls and rotates at a high speed, thereby splitting the film into a mesh form.

A moving speed of the film in the above splitting process is generally 1 to 1000 m/min, preferably 10 to 500 m/min. Also, the rotating speed (peripheral speed) of the splitter can be appropriately chosen according to properties and moving speed of the film, and a desired shape of the split web 2. In general, it is 10 to 5000 m/min, preferably 50 to 3000 m/min.

The thus-split film is widened if desired and subjected to a heat treatment process 117. After that, (4) in a winding process 118, the film is wound up into a predetermined length and supplied as the split web 2 as one uniaxially oriented member of the original fabric for the mesh-like nonwoven fabric 1.

FIG. 9 is a schematic diagram showing a manufacturing process for the mesh-like nonwoven fabric 1. FIG. 9 illustrates the manufacturing process including a step of laminating the slit web 3 and the split web 2 illustrated as the wound member in FIG. 8. As shown in FIG. 9, the process mainly includes (1) a step of forming a multilayer film as original fabric for the slit web 3, (2) a slitting step for forming a slit at almost right angles to the length direction of the multilayer film, (3) a step of uniaxially orienting the multilayer slit film, (4) a press-bonding step for laminating the split web 2 on the uniaxially oriented slit web 3 and subjecting the laminated webs to thermocompression bonding.

Each step is described below. (1) In the step of forming a multilayer film in FIG. 9, a thermoplastic resin is supplied to a main extruder 311, linear low-density polyethylene is supplied to a sub-extruder 312, the thermoplastic resin extruded from the main extruder 311 is used for an inner layer, and the linear low-density polyethylene extruded from the sub-extruder 312 is used for an outer layer so as to form a two-layer film by inflation molding. Here, the thermoplastic resin forms the thermoplastic resin layer 6′ of FIGS. 7A and 7B, and the linear low-density polyethylene forms the linear low-density polyethylene layer 7-1′, 7-2′ of FIGS. 7A and 7B. In the illustrated example of FIG. 9, film formation is executed with two extruders through a multilayer annular die 313 by use of blow-down water-cooled inflation 314. Similar to the above example of FIG. 8, as the manufacturing process for the multilayer film, a multilayer inflation method, a multilayer T-die method, and the like can be used without any particular limitations.

(2) In the slitting step, the above formed multilayer film is pinched and flattened and then, rolled to be slightly oriented, after which obliquely-angled horizontal slits 315 are formed at almost right angles to the travel direction. Conceivable examples of the slitting method include a method of cutting through the film with a sharp cutting edge of a razor blade, a high-speed rotating blade, or the like, and a method of forming a slit with a scoring cutter, a shear cutter, etc. In particular, a slitting method using a heat cutter is most preferable. Examples of such a heat cutter are disclosed in JP S61-11757 B, U.S. Pat. No. 4,489,630, U.S. Pat. No. 2,728,950, and the like.

(3) In the orienting step, the above slit multilayer film is subjected to uniaxial orientation 316 in the width direction. Orienting methods with a tenter, a pulley, and the like are applicable. Of these, the pulley is preferred because it is a compact and economical device. Examples of the method with a pulley can be found in British Patent No. 849,436 and JP S57-30368 B. The conditions such as the orientation temperature are the same as those in FIG. 8.

The slit web 3 (horizontal web) as the above uniaxially oriented member is transferred to (4) a thermocompression bonding step 317. On the other hand, the split web 2 (vertical web) as the uniaxially oriented member produced by the method of FIG. 8 is delivered from an original fabric feeder roll 210 and transferred at a predetermined feed speed to the widening step 211 and then widened severalfold by the aforementioned widening device, and optionally heat-treated if necessary. This vertical web is laminated on the horizontal web and transferred to the thermocompression bonding step 317 in which the vertical web and the horizontal web are laminated so as to cross their orientation axes and subjected to thermocompression bonding. Specifically, the vertical web 2 and the horizontal web 3 are sequentially passed between a heat cylinder 317a with a mirror-finished outer circumference and a mirror-finished roll 317b, 317c under the nip pressure and integrally bonded to each other through thermocompression bonding. As a result, contact portions of the adjacent vertical web 2 and horizontal web 3 are entirely surface-bonded. After having undergone defect inspection for checking the presence of unbound portions, etc., the film is transferred to a winding step 318 to obtain the wound mesh-like nonwoven fabric 1 (product).

### (Second Mesh-Like Structure: Nonwoven Fabric Produced by Laminating Split Webs in Vertical and Horizontal Directions)

This second mesh-like structure is mesh-like nonwoven fabric, which is produced by laminating, in vertical and horizontal directions, uniaxially oriented members obtained by splitting a vertically uniaxially-stretched multilayer film and widening the split film so as to cross their orientation directions, preferably at almost right angles. To be specific, in the second mesh-like structure, both the uniaxially oriented members to be laminated correspond to the mesh-like nonwoven fabric made up of the split web 2 of the above first mesh-like structure.

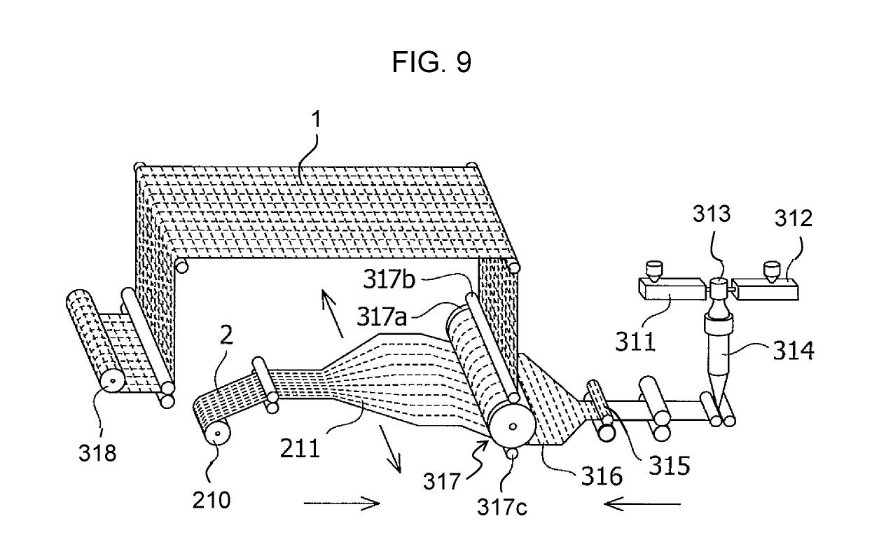

FIG. 10 is a conceptual diagram illustrating a manufacturing process for nonwoven fabric as the second mesh-like structure. This mesh-like nonwoven fabric is produced by laminating in vertical and horizontal directions, two split webs 2 shown in FIGS. 6A and 6B. In FIG. 10, a split web 2-1 (vertical web) produced as shown in FIG. 8 is delivered from an original fabric feeder roll 410 and transferred at a predetermined feed speed to a widening step 411 and then widened severalfold by a widening device (not shown) and optionally heat-treated if necessary.

Similar to the vertical web, the other split web 2-2 (horizontal web) is delivered from an original fabric feeder roll 510 and transferred at a predetermined feed speed to a widening step 511 and then widened severalfold by a widening device (not shown) and optionally heat-treated if necessary. After that, the horizontal web is cut into the same length as the width of the vertical web 2-1 and supplied orthogonally to the running film of the vertical web. In a laminating step 412, these webs are laminated through each bonding layer in the vertical and horizontal directions so as to cross their orientation axes. In a thermal bonding step 417, the vertically and horizontally laminated vertical web 2-1 and horizontal web 2-2 are sequentially passed between a heat cylinder 417a with a mirror-finished outer circumference and a mirror-finished roll 417b, 417c under the nip pressure. Consequently, the vertical web 2-1 and the horizontal web 2-2 are integrally bonded to each other through thermocompression bonding. Also, contact portions of the adjacent vertical web 2-1 and horizontal web 2-2 are entirely surface-bonded. The thus-integrated vertical web 2-1 and horizontal web 2-2 are wound up in a winding step 418 as a wound one of vertically and horizontally laminated mesh-like nonwoven fabric.

The thus-produced second mesh-like structure also has similar numerical characteristics to the first mesh-like structure in terms of fabric mass per unit area, tensile strength in both of vertical and horizontal directions, and the thickness and adhesion of the linear low-density polyethylene layer. This structure can produce the same advantageous effects as in the first embodiment when bonded to a nylon film.

### (Third Mesh-Like Structure: Mesh-Like Nonwoven Fabric and Woven Fabric Made Up of Uniaxially Oriented Tape)

This third mesh-like structure is nonwoven fabric produced by laminating uniaxially oriented tapes in vertical and horizontal directions or nonwoven fabric produced by weaving them. The uniaxially oriented tape is made up of a thermoplastic resin layer and a linear low-density polyethylene layer and produced by uniaxially orienting a multilayer film having at least two layers, in the vertical or horizontal direction and cutting the uniaxially oriented film into stretched multilayer tapes.

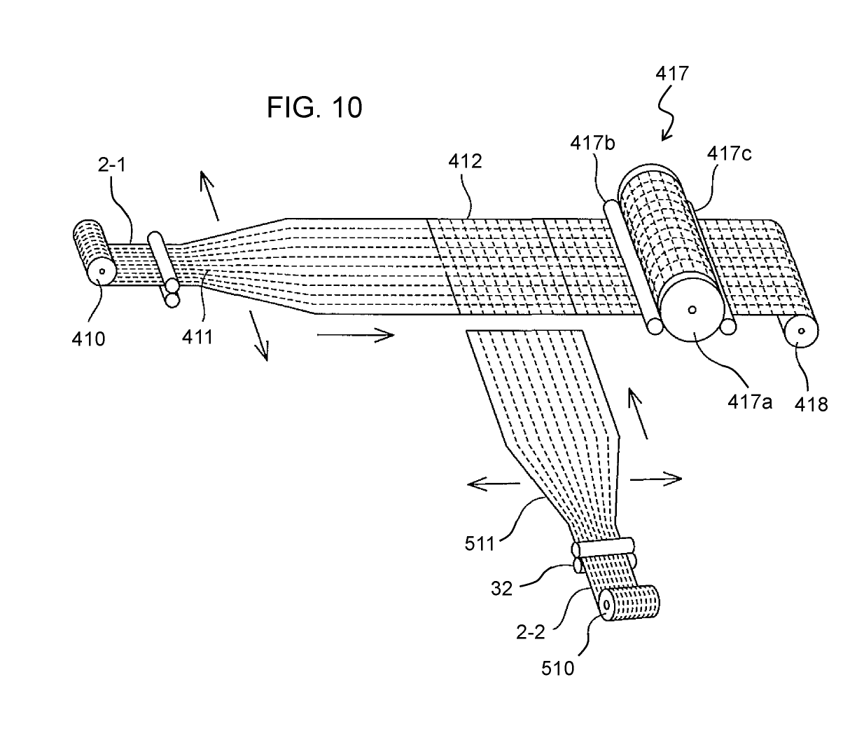

The two uniaxially oriented members of the third mesh-like structure are both composed of a group of plural uniaxially oriented tapes. As shown in FIG. 11, in the nonwoven fabric 9, the group of plural uniaxially oriented tapes 8, 8, . . . are laminated in vertical and horizontal directions so as to cross the stretching directions thereof at almost right angles, and then welded or bonded. To be specific, contact portions of the adjacent uniaxially oriented tapes 8 crossing each other are surface-bonded.

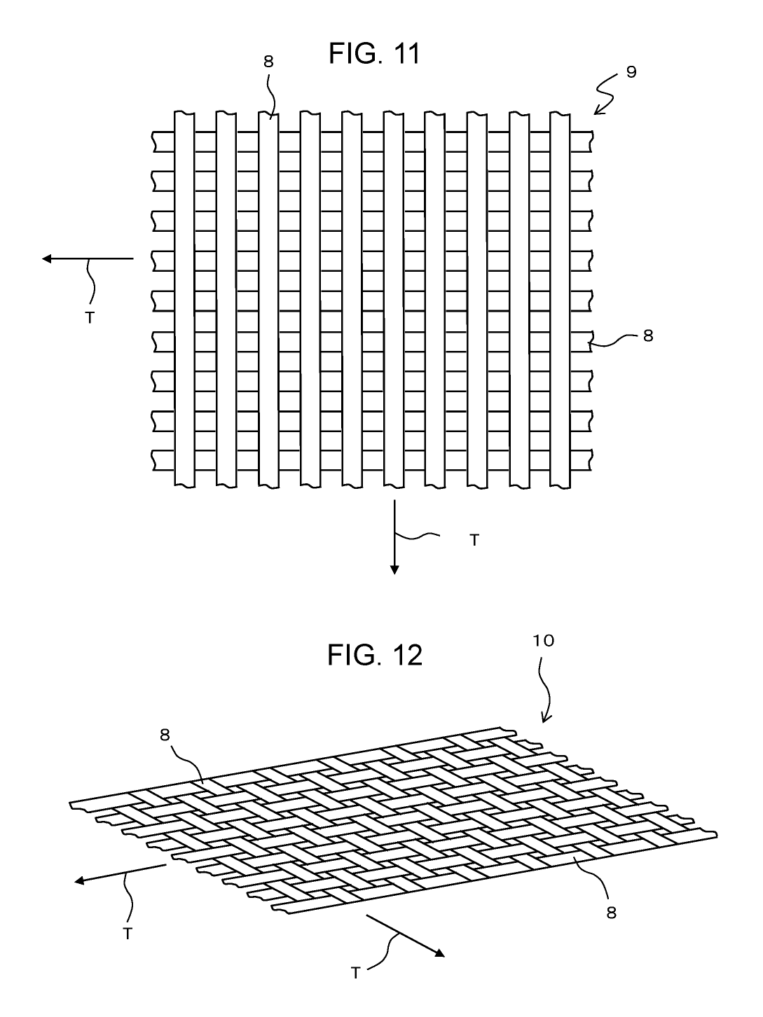

On the other hand, as shown in FIG. 12, in the woven fabric 10, uniaxially oriented tapes 8, 8, . . . are woven by a freely selected weaving method so that one group of uniaxially oriented tapes 8, 8, . . . serve as warp, and another group of uniaxially oriented tapes 8, 8, . . . serve as weft. Then, they are welded or bonded. In the woven fabric 10, the uniaxially oriented tapes 8 cross each other at right angles. This means that their orientation axes T cross each other at right angles. Also, in the woven fabric 10, contact portions of the adjacent uniaxially oriented tapes 8 crossing each other are surface-bonded.

Similar to the split web 2 of the above first mesh-like structure, the uniaxially oriented tape can be produced by forming an original fabric film having a two- or three-layer structure with a multilayer inflation method or multilayer T-die method and uniaxially stretching the film three to fifteen-fold, preferably three to ten-fold in the vertical direction and then, cutting the film along the stretching direction into the width of 2 mm to 7 mm, for example. Alternatively, the uniaxially oriented tape can be produced similarly by forming an original fabric film having two or three-layer structure and cutting the film into the above width along the machine direction and then, uniaxially stretching the film three to fifteen-fold, preferably three to ten-fold in the vertical direction. In such a uniaxially oriented tape, the stretching direction (orientation direction) corresponds to the longitudinal direction of the tape.

In the mesh-like structure made up of nonwoven fabric having uniaxially oriented tapes laminated as above, the plural uniaxially oriented tapes corresponding to the warp are arranged in parallel to each other at regular intervals. These tapes correspond to one uniaxially oriented member. On the other hand, the other uniaxially oriented member corresponds to the other uniaxially oriented tapes as the weft, which are arranged in parallel to each other at regular intervals and are laminated on the above group of uniaxially oriented tapes. The warp and weft are referred to herein for defining a relative relationship therebetween and can be interchanged. In this case, the one group of uniaxially oriented tapes and the other group of uniaxially oriented tapes are laminated so as to cross the longitudinal directions, i.e., orientation directions thereof at almost right angles. Then, a contact surface between the warp and weft is thermally welded to obtain the mesh-like nonwoven fabric as the third mesh-like structure. In this case, the thermally welded or bonded form is the same as that of the first mesh-like structure.

Note that if the uniaxially oriented tape has two layers: the thermoplastic resin layer and the linear low-density polyethylene layer, the warp and weft are laminated so that their linear low-density polyethylene layers contact each other. The uniaxially oriented tape corresponding to the warp and the uniaxially oriented tape corresponding to the weft can be the same or different in terms of the composition, the thickness, the width, and the tape-to-tape distance as long as the above conditions for the composition, the layer thickness, etc. of the uniaxially oriented member are satisfied. The woven fabric can be produced in the same manner except that the plural uniaxially oriented tapes are woven instead of being laminated.

The third mesh-like structure also has similar characteristics to the first mesh-like structure in terms of fabric mass per unit area, the tensile strength, the thickness of the linear low-density polyethylene layer, and the adhesion between the uniaxially oriented members and can produce the same advantageous effects as in the first embodiment when bonded to a nylon film. Note that in this embodiment, the adhesion between the uniaxially oriented members indicates adhesion between the group of uniaxially oriented tapes corresponding to the warp and the group of uniaxially oriented tapes corresponding to the weft, and this value is also within the range described in the illustrated example of the first mesh-like structure. The tensile strength indicates tensile strength in one or both of the orientation directions of the uniaxially oriented tapes corresponding to the warp and the uniaxially oriented tapes corresponding to the weft.

### (Fourth Mesh-Like Structure: Mesh-Like Nonwoven Fabric Made Up of Split Web and Uniaxially Oriented Tape)

This fourth mesh-like structure is nonwoven fabric produced by laminating a uniaxially oriented member including base fibers extending in parallel to each other, and branch fibers connecting adjacent base fibers, and a uniaxially oriented tape group layer.

A description is given below of the fourth mesh-like structure, focusing on the form in which three layers of uniaxially oriented member are laminated. That is, in the fourth mesh-like structure of the present invention, typically, a first uniaxially oriented member is the split web 2, and a second uniaxially oriented member is made up of a group of plural uniaxially oriented tapes. In addition, the fourth mesh-like structure further includes a third uniaxially oriented member made up of a group of plural uniaxially oriented tapes obliquely crossing the above group of uniaxially oriented tapes constituting the second uniaxially oriented member.

Such a mesh-like structure is nonwoven fabric produced by laminating a split web including base fibers extending in parallel to each other, and branch fibers for connecting adjacent base fibers, a first uniaxially oriented tape group layer made up of a group of uniaxially oriented tapes arranged obliquely to the orientation direction of the split web and extending in parallel to each other, and a second uniaxially oriented tape group layer made up of a group of uniaxially oriented tapes arranged obliquely to the orientation direction of the split web and inversely to the first uniaxially oriented tape group layer, and extending in parallel to each other. In the fourth mesh-like structure, the uniaxially oriented tape is laminated on the split web at the angle α′ to the orientation direction of the split web. Moreover, another uniaxially oriented tape is laminated obliquely to the uniaxially oriented tape at the angle α to the orientation axis L. In this case, the angles α and α′ can be the same or different, and can be, for example, 45 to 60 degrees.

The manufacturing process for the split web and uniaxially oriented tapes constituting the fourth mesh-like structure is similar to those of the first and third mesh-like structures, and the split web and the tapes can be manufactured in the same way. By welding or bonding contact portions thereof, the fourth mesh-like structure can be obtained.

In addition to the split web as described in detail above, the following uniaxially oriented member can be used together with the uniaxially oriented tapes in the fourth mesh-like structure. That is, a number of slits are formed in an original fabric film with the same structure as that of the split web, in the width direction, and the slit film is stretched in the width direction at the same stretching rate as the split web to thereby obtain a uniaxially oriented member (slit web), for example. More specifically, a slit web having a pattern rotated by ±90° from the position of the split web in plan view or other such patterns, can be also used. In this case as well, the slit web and the first and second uniaxially oriented tape group layers can be laminated obliquely to each other's orientation directions in the same way as above. Alternatively, the following mesh-like structure can be used, in which two layers including a split web 2b or slit web and the first uniaxially oriented tape group layer are laminated so that the orientation direction of the split web 2b or slit web crosses the longitudinal direction of the group of uniaxially oriented tapes.

The fourth mesh-like structure also has the same characteristics as the first mesh-like structure in terms of fabric mass per unit area, the tensile strength, the thickness of the linear low-density polyethylene layer, and the adhesion between the uniaxially oriented members, and can produce the same advantageous effects as in the first embodiment when bonded to a nylon film. The adhesion between the uniaxially oriented members indicates adhesion between every possible combination of uniaxially oriented members, i.e., the split web or slit web and one or two uniaxially oriented tape group layers. This value also shows numerical characteristics within the range described in the illustrated example of the first mesh-like structure. The tensile strength indicates tensile strength in one or both of the orientation direction of the split web or the slit web, and the orientation direction of the group of uniaxially oriented tapes. The value of the tensile strength is within the range described in the illustrated example of the first mesh-like structure.

### (Test Results)

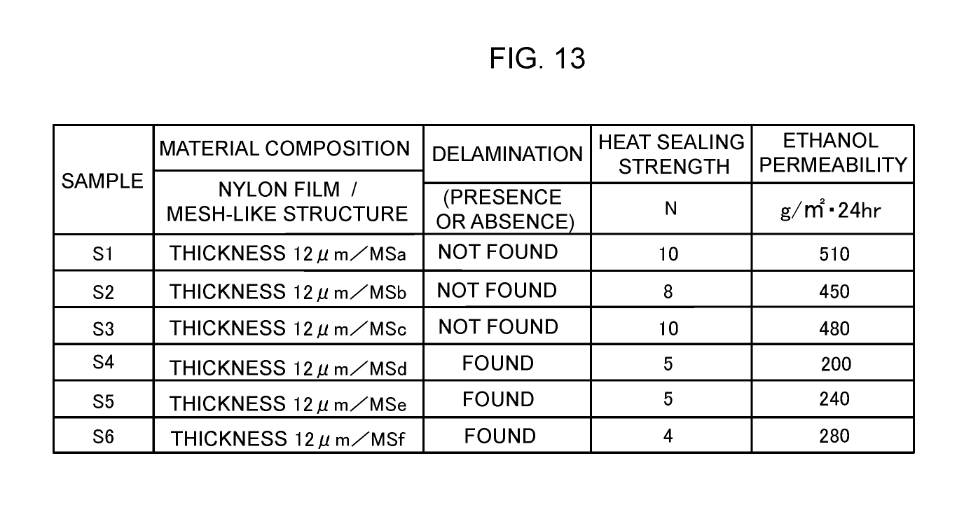

FIG. 13 shows results of measuring laminate strength, heat sealing strength (presence or absence of delamination), and moisture and ethanol permeabilities of samples prepared with different material compositions as the alcohol transpiration agent package according to the second embodiment of the present invention.

Samples S1 to S3 correspond to the member of the second embodiment of the present invention. They were produced by making a bag with a sheet material in which a nylon film, Toyobo's Harden (registered trademark) (nonporous nylon film with a thickness of 12 μm) and a mesh-like structure were bonded together, so as to obtain an alcohol transpiration agent package. In these samples S1 to S3, HY444 (high-density polyethylene referred to as resin A) available from Japan Polyethylene Corporation was used for the thermoplastic resin layer 6 as a main layer of the split web 2 as one uniaxially oriented member of the mesh-like structure, and CB2001 (linear low-density polyethylene referred to as resin B) available from Sumitomo Chemical Co., Ltd., was laminated on both sides of the thermoplastic resin layer 6 as the bonding layers 7-1 and 7-2 by a water-cooled inflation method. The stretching rate in the vertical direction was set to be eight-fold upon manufacturing the split web 2.

Also, in the slit web 3 as the other uniaxially oriented member, the resin A was used for the thermoplastic resin layer 6′ as a main layer. In the samples S1 and S2, the resin B was laminated as the bonding layers 7-1′ and 7-2′ on both sides of the thermoplastic resin layer 6′. In the sample S3, the resin B was laminated as the bonding layer 7-1′ on one side of the thermoplastic resin layer 6′ by the water-cooled inflation method. The stretching rate in the width direction was the same as in the vertical direction, at the time of producing the slit web 3. Moreover, the split web 2 and the slit web 3 were bonded through heat welding at 121° C.

The fabric mass per unit area and thickness of each layer of the samples S1 to S3 (the thickness before/after stretching) are shown in Table 1 below. Here, the “outer layer thickness” indicates the thickness of a bonding layer on one side. Moreover, the mesh-like structure with a fiber pitch of 2 mm or less, called a fine mesh, was used, which ensured a finer mesh structure and had a fine pitch between fibers. Note that the resin B was linear low-density polyethylene having long-chain branching and polymerized with a metallocene catalyst.

TABLE 1

| | Mesh-like | Mesh-like | Mesh-like |
|---|---|---|---|
| | structure MSa | structure MSb | structure MSc |
| Main layer thickness | 39.0 | 33.5 | 33.5 |
| (μm) | | | |
| Outer layer thickness | 2.5 | 5.5 | 5.5 |
| (μm) | | | |
| Fabric mass per unit | 29 | 26 | 31 |
| area (g/m²) | | | |

The above three types of mesh-like structures differing in thickness or fabric mass per unit area were respectively bonded to a nonporous nylon film by thermal lamination to prepare the sheet material 11. The sheet material 11 was folded with the mesh-like structure 12 inside and the linear low-density polyethylene layer of the mesh-like structure 12 was used as a heat sealing layer for bonding two sides 11a and 11c orthogonal to the fold to thereby obtain a bag. After that, the alcohol transpiration agent 16 was filled in this bag and in this state, the linear low-density polyethylene layer of the mesh-like structure 12 was used as a heat sealing layer for bonding the remaining side 11b to thereby seal the alcohol transpiration agent 16. In this way, three samples S1 to S3 were prepared.

Regarding the bag made with the nonporous nylon film and a mesh-like structure MSa of the sample S1, its heat sealing strength was 10 N and no delamination was found. The ethanol permeability was 510 g/m²·24 hr. These characteristics are satisfactory as the alcohol transpiration agent package.

Also, regarding the bag made with the nonporous nylon film and the mesh-like structure MSb of the sample S2, its heat sealing strength was 8 N and no delamination was found. The ethanol permeability was 450 g/m²·24 hr. These characteristics are satisfactory as the alcohol transpiration agent package.

Furthermore, regarding the bag made with the nonporous nylon film and the mesh-like structure MSc of the sample S3, its heat sealing strength was 10 N, and no delamination was found. The ethanol permeability was 480 g/m²·24 hr. These characteristics are also satisfactory as the alcohol transpiration agent package.

In contrast, samples S4 to S6 are given as comparative examples. The mesh-like structure was prepared under the same conditions, inclusive of the layer structure, the stretching rate, and the heat welding temperature as the samples S1 to S3 except that LE541H (low-density polyethylene: resin C) available from Japan Polyethylene Corporation was used as a bonding layer in place of the resin B. The thickness of each layer of the samples S4 to S6 are as shown in Table 2 below. These mesh-like structures were bonded to a nylon film, Toyobo's Harden (registered trademark) (nonporous nylon film with a thickness of 12 μm) similar to the samples S1 to S3 to obtain a sheet material. A bag was formed with the sheet material to thereby obtain an alcohol transpiration agent package.

TABLE 2

| | Mesh-like | Mesh-like | Mesh-like |
|---|---|---|---|
| | structure MSd | structure MSe | structure MSf |
| Main layer thickness | 44.9 | 60.7 | 33.5 |
| (μm) | | | |
| Outer layer thickness | 4.6 | 4.8 | 5.5 |
| (μm) | | | |
| Fabric mass per unit | 34 | 47 | 15 |
| area (g/m²) | | | |

Regarding the bag made with the nonporous nylon film and the mesh-like structure MSd of the sample S4, the heat sealing strength was 5 N, and delamination was observed. The ethanol permeability was 200 g/m²·24 hr. Consequently, the strength was low. These characteristics are not satisfactory as the alcohol transpiration agent package.

Also, regarding a bag made with the nonporous nylon film and the mesh-like structure MSe of the sample S5, the heat sealing strength was 5 N, and delamination was observed. The ethanol permeability was 240 g/m²·24 hr. In this case, the strength was lower than the sample S4. These characteristics are not satisfactory as the sheet material as well as the alcohol transpiration agent package.

Moreover, regarding the bag made with the nonporous nylon film and the mesh-like structure MSf of the sample S6, its heat sealing strength was 4 N, and delamination was observed. The ethanol permeability was 280 g/m²·24 hr. Similar to the sample S5, the strength was insufficient. These characteristics are not satisfactory as the sheet material as well as the alcohol transpiration agent package.

As mentioned above, the samples S1 to S3 fully satisfied the characteristics necessary for the alcohol transpiration agent package. On the other hand, the sample S4 showed low heat sealing strength and suffered from delamination although having almost the same fabric mass per unit area and tensile strength, and therefore could not be utilized as the alcohol transpiration agent package. The samples S4 and S5 showed low heat sealing strength and suffered from delamination. Furthermore, they showed low laminate strength and could not be employed in actual use as the sheet material as well as the alcohol transpiration agent package.

### REFERENCE SYMBOL LIST

1 mesh-like nonwoven fabric
2 split web (mesh-like film)
21 base fiber
22 branch fiber
2-1 vertical web
2-2 horizontal web
3 slit web
6, 6′ thermoplastic resin layer (mesh-like film)
7-1, 7-1′metallocene LLDPE layer (bonding layer)
7-2, 7-2′metallocene LLDPE layer (bonding layer)
8 uniaxially oriented tape
9 nonwoven fabric
10 woven fabric
11 sheet material
11a, 11b, 11c side of sheet material
12 mesh-like structure
12a, 13a surface area
13 nylon film (polyamide-based resin film)
14 printed surface
15 alcohol transpiration agent package
16 alcohol transpiration agent
L, T orientation axis

1. A sheet material comprising:
a mesh-like structure which is made up of two or more uniaxially oriented members including a thermoplastic resin layer and a linear low-density polyethylene layer laminated on at least one side of the thermoplastic resin layer, and which is obtained by laminating or weaving the two or more uniaxially oriented members through the linear low-density polyethylene layer so as to cross orientation axes of the two or more uniaxially oriented members; and
a polyamide-based resin film laminated on the mesh-like structure through the linear low-density polyethylene layer,
the mesh-like structure and the polyamide-based resin film being bonded together by the melted linear low-density polyethylene layer of the mesh-like structure.

2. The sheet material according to claim 1, wherein the linear low-density polyethylene layer contains linear low-density polyethylene having long-chain branching in a molecular chain.

3. The sheet material according to claim 1, wherein the linear low-density polyethylene layer contains linear low-density polyethylene polymerized with a metallocene catalyst, and the mesh-like structure is obtained by weaving the two or more uniaxially oriented members through the linear low-density polyethylene layer.

4. The sheet material according to claim 1, wherein the polyamide-based resin film has alcohol permeability.

5. The sheet material according to claim 1, wherein the uniaxially oriented member includes a first linear low-density polyethylene layer laminated on one side of the thermoplastic resin layer and a second linear low-density polyethylene layer laminated on the other side of the thermoplastic resin layer, and
the first and second linear low-density polyethylene layers contain linear low-density polyethylene having a melt flow rate of 0.5 to 10 g/10 min and density of 0.910 to 0.940 g/cm³.

6. The sheet material according to claim 1, wherein the two or more uniaxially oriented members constitute at least one of a uniaxially oriented mesh-like film and a uniaxially oriented tape.

7. The sheet material according to claim 1, wherein the mesh-like structure satisfies characteristics that fabric mass per unit area is 5 to 70 g/m², a thickness of the linear low-density polyethylene layer is 2 to 10 μm, adhesion between the uniaxially oriented members is 10 to 60 N, and tensile strength is 20 to 600 N/50 mm.

8. An alcohol transpiration agent package in the form of a bag that is heat-sealed with an alcohol transpiration agent filled therein, the package comprising:
a mesh-like structure which is made up of two or more uniaxially oriented members including a thermoplastic resin layer and a linear low-density polyethylene layer having long-chain branching in a molecular chain and laminated on at least one side of the thermoplastic resin layer, and which is obtained by laminating or weaving the two or more uniaxially oriented members through the linear low-density polyethylene layer so as to cross orientation axes of the two or more uniaxially oriented members;
a polyamide-based resin film laminated on the mesh-like structure through the linear low-density polyethylene layer; and
a printed surface formed on a side of the polyamide-based resin film at which the mesh-like structure is laminated,
wherein the alcohol transpiration agent is filled in the bag that is formed with the mesh-like structure inside, and
the linear low-density polyethylene layer of the mesh-like structure is used as a heat sealing layer for bonding contact portions of the mesh-like structure to seal the bag.

9. The alcohol transpiration agent package according to claim 8, wherein the mesh-like structure and the polyamide-based resin film are bonded together by the melted linear low-density polyethylene layer of the mesh-like structure.

10. The alcohol transpiration agent package according to claim 8, further comprising a polar functional group introduced into the mesh-like structure and the printed surface at a laminated surface portion between the mesh-like structure and the polyamide-based resin film.
